(19) United States
(12) Patent Application Publication
(10) Pub. No.: US 2009/0263697 A1
(43) Pub. Date: Oct. 22, 2009

(54) FUEL CELL

(75) Inventors: Keiji Hashimoto, Aichi-ken (JP); Eiichirou Morozumi, Aichi-Ken (JP); Michi Hashiba, Gifu-Ken (JP)

Correspondence Address: ROSSI, KIMMS & McDOWELL LLP., 20609 Gordon Park Square, Suite 150, Ashburn, VA, 20147, US

(73) Assignee: TOYOTA SHATAI KABUSHIKI KAISHA, Kariya-shi, Aichi-ken (JP)

(21) Appl. No.: 11/910,564

(22) PCT Filed: Jul. 13, 2006
(86) PCT No.: PCT/JP2006/314332

§ 371 Date: Oct. 3, 2007

(30) Foreign Application Priority Data
Sep. 2, 2005 (JP) 2005-254702

(51) Int. Cl. H01M 8/10

(52) U.S. Cl. 429/30

(57) ABSTRACT

A fuel cell stack includes a plurality of cells each including an MEA 10 sandwiched by separators 20. A hydrogen gas supply pipe 31 and an air supply pipe 32 for externally supplying gas, and a hydrogen gas discharge pipe 35 and an air discharge pipe 36 for discharging unreacted gas are connected to the stack. Gas-supply-side valves 33 and 34 are installed in the pipes 31 and 32, respectively. Gas-discharge-side valves 37 and 38 are installed in the pipes 35 and 36, respectively. The valves 33 and 37 close an anode-electrode-layer-side space including an anode electrode layer. The valves 34 and 38 close a cathode-electrode-layer-side space including a cathode electrode layer. This structure prevents introduction of new air, thereby suppressing an increase in the concentration of nitrogen gas in the anode-electrode-layer-side space.

### TECHNICAL FIELD

The present invention relates to a fuel cell, and particularly to a polymer electrolyte fuel cell—or proton exchange membrane (PEM) type fuel cell—including a solid-polymer-membrane-based electrode assembly.

### BACKGROUND ART

A polymer electrolyte fuel cell includes a membrane-electrode assembly (MEA) having an electrolyte membrane formed of an ion exchange membrane which selectively allows passage of cations (specifically hydrogen ions); an anode electrode layer including a catalyst layer and a gas diffusion layer and disposed on one surface of the electrolyte membrane where fuel gas (e.g., hydrogen gas) is introduced; and a cathode electrode layer including a catalyst layer and a gas diffusion layer and disposed on the opposite surface of the electrolyte membrane where oxidizer gas (e.g., air) is introduced.

In such a polymer electrolyte fuel cell, when hydrogen gas is supplied to the anode electrode layer of the MEA, hydrogen gas is dissociated into hydrogen ions and electrons, and the generated hydrogen ions (i.e., cations) move through the electrolyte membrane toward the cathode electrode layer. When air is supplied to the cathode electrode layer of the MEA, water is produced from oxygen contained in air, hydrogen ions, and electrons. On the basis of these reactions, the polymer electrolyte fuel cell generates electricity and supplies it to the exterior thereof.

In a state where the polymer electrolyte fuel cell is generating electricity, supplied hydrogen gas and air are consumed by reactions in the MEA. However, in a state where the polymer electrolyte fuel cell is not generating electricity, in some cases, there may arise a phenomenon in which hydrogen gas and air present around the MEA—more specifically, hydrogen gas present in the anode electrode layer and air present in the cathode electrode layer—pass through the electrolyte membrane (a so-called “cross-leak” phenomenon). This phenomenon is highly likely to occur when partial pressure of gas present in the anode electrode layer is not in equilibrium with that of gas present in the cathode electrode layer.

When, as a result of cross-leak, hydrogen gas passes from the anode electrode layer to the cathode electrode layer, hydrogen gas which has reached the cathode electrode layer reacts with oxygen gas contained in air to form water, whereby the hydrogen gas is consumed. Similarly, when oxygen gas contained in air passes from the cathode electrode layer to the anode electrode layer, oxygen gas which has reached the anode electrode layer reacts with hydrogen gas to form water, whereby the oxygen gas is consumed. However, when nitrogen gas contained in air passes from the cathode electrode layer to the anode electrode layer, nitrogen gas which has reached the anode electrode layer is not consumed and is present as impurities in the vicinity of the anode electrode layer, since nitrogen gas is an inert gas. When the polymer electrolyte fuel cell resumes generating electricity, the presence of nitrogen gas in the vicinity of the anode electrode layer hinders supply of sufficient hydrogen gas for reaction, potentially impairing starting characteristics of the fuel cell.

In order to cope with the above problem, for example, Patent Document 1 proposes a fuel cell system in which, when the concentration of impurities on the anode electrode layer increases, output is controlled accordingly. This fuel cell system is designed to calculate the difference between the stack temperature and the outside air temperature when the operation of the fuel cell is stopped, and the difference between the stack temperature and the outside air temperature when the operation of the fuel cell is started. On the basis of the calculation, a temperature ratio between the differences is obtained, and from the thus-obtained temperature ratio, the concentration of nitrogen which has passed through an electrolyte membrane from the cathode electrode layer to the anode electrode layer is estimated. Output of the fuel cell is limited in accordance with the estimated concentration of nitrogen, thereby suppressing excessive generation of electricity under conditions of high impurity concentration in the anode electrode layer.

Patent Document 1: Japanese Patent Application Laid-Open (kokai) No. 2004-172026

According to the above-mentioned conventional fuel cell system, for example, when the fuel cell resumes operation after long-term suspension of operation, output is limited so as to suppress excessive generation of electricity, since the concentration of impurities (i.e., the concentration of nitrogen gas) in the anode electrode layer is increased. By this procedure, load on the fuel cell can be reduced, thereby suppressing shortening of life of the fuel cell. Also, limitation on output can suppress, to the greatest possible extent, a state of unstable output which would otherwise be highly likely to arise immediately after start of generation of electricity.

However, this conventional fuel cell system assumes that, particularly during suspension of operation of the fuel cell, the concentration of impurities; i.e., the concentration of nitrogen gas, in the anode electrode layer is increased. That is, the conventional fuel cell system does not actively suppress passage of nitrogen gas from the cathode electrode layer to the anode electrode layer. In other words, the conventional fuel cell system does not actively suppress an increase in the concentration of nitrogen gas in the anode electrode layer. Limitation on output in view of an increase in the concentration of nitrogen gas in the anode electrode layer sacrifices starting characteristics of the fuel cell, leading to impaired convenience of the fuel cell. Therefore, development of a fuel cell having excellent starting characteristics and improved convenience has been keenly desired.

### DISCLOSURE OF THE INVENTION

The present invention has been achieved with an aim to solve the above problems, and an object of the invention is to provide a fuel cell which exhibits good starting characteristics and provides improved convenience, through suppression of an increase in the concentration of impurities in an anode electrode layer.

To achieve the above object, according to a feature of the present invention, a fuel cell comprises a membrane-electrode assembly comprising an electrolyte membrane formed of an ion exchange membrane, an anode electrode layer formed on one surface of the electrolyte membrane, and a cathode electrode layer formed on the opposite surface of the electrolyte membrane; fuel-side and oxidizer-side separators providing gas passageways for introducing fuel gas and oxidizer gas into the membrane-electrode assembly; a gas supply-discharge member for externally supplying the fuel gas and the oxidizer gas to and discharging unreacted fuel gas and unreacted oxidizer gas from a fuel cell stack comprising a plurality of cells each including at least the membrane-electrode assembly and the separators; and a closing member for closing an anode-electrode-layer-side space and a cathode-electrode-layer-side space, the anode-electrode-layer-side space being defined by the membrane-electrode assembly, the gas passageway of the fuel-side separator, and the gas supply-discharge member and including the anode electrode layer, and the cathode-electrode-layer-side space being defined by the membrane-electrode assembly, the gas passageway of the oxidizer-side separator, and the gas supply-discharge member and including the cathode electrode layer.

By virtue of this feature, for example, in a state where the fuel cell suspends generation of electricity, the closing member can close the anode-electrode-layer-side space, which is filled with fuel gas (e.g., hydrogen gas), and the cathode-electrode-layer-side space, which is filled with oxidizer gas (e.g., air). This can prevent, in particular, introduction of new oxidizer gas into the cathode-electrode-layer-side space, thereby limiting the quantity of nitrogen gas in oxidizer gas present in the cathode-electrode-layer-side space. Accordingly, even when cross-leak occurs between the cathode-electrode-layer-side space and the anode-electrode-layer-side space, the quantity of nitrogen gas that can permeate from the cathode-electrode-layer-side space to the anode-electrode-layer-side space can be limited, thereby effectively suppressing an increase in the concentration of nitrogen gas in the anode-electrode-layer-side space. Thus, immediately after start of operation of the fuel cell, fuel gas can be sufficiently supplied to the anode electrode layer, whereby the fuel cell can exhibit good starting characteristics and can provide improved convenience.

According to another feature of the present invention, the closing member is disposed in the vicinity of a position of connection between the fuel cell stack and the gas supply-discharge member. This feature attains a reduction in the volume of the anode-electrode-layer-side space and the volume of the cathode-electrode-layer-side space. In particular, since reducing the volume of the cathode-electrode-layer-side space reduces the quantity of nitrogen gas that can permeate to the anode-electrode-layer-side space, an increase in the concentration of nitrogen gas in the anode-electrode-layer-side space can be more effectively suppressed. Thus, the fuel cell can exhibit good starting characteristics and can provide improved convenience.

According to still another feature of the present invention, the anode-electrode-layer-side space to be closed by means of the closing member is greater in volume than the cathode-electrode-layer-side space to be closed by means of the closing member. Even when cross-leak causes nitrogen gas to pass from the cathode-electrode-layer-side space to the anode-electrode-layer-side space, this feature reduces the concentration of nitrogen gas relative to the concentration of fuel gas (hydrogen gas) filling the anode-electrode-layer-side space. Thus, also in this case, the fuel cell can exhibit good starting characteristics and can provide improved convenience.

According to a further feature of the present invention, the separators each include a plurality of streaky recess portions and streaky projection portions for forming gas passageways; and the streaky recess portions or the streaky projection portions of the fuel-side separator used to form the anode-electrode-layer-side space are greater in size than the streaky recess portions or the streaky projection portions of the oxidizer-side separator used to form the cathode-electrode-layer-side space.

By means of increasing the size of the streaky recess portions or the streaky projection portions of the fuel-side separator used to form the anode-electrode-layer-side space, the volume of the anode-electrode-layer-side space can be made greater than the volume of the cathode-electrode-layer-side space. Even when cross-leak causes nitrogen gas to pass from the cathode-electrode-layer-side space to the anode-electrode-layer-side space, this feature reduces the concentration of nitrogen gas relative to the concentration of fuel gas (hydrogen gas) filling the anode-electrode-layer-side space. Thus, also in this case, the fuel cell can exhibit good starting characteristics and can provide improved convenience.

In the case where the volume of the anode-electrode-layer-side space is made greater than the volume of the cathode-electrode-layer-side space; in other words, in the case where the volume of the cathode-electrode-layer-side space is made small as compared with the volume of the anode-electrode-layer-side space, drainage of water formed in the cathode electrode layer in association with the fuel cell generating electricity may be impaired. This potentially causes a failure to exhibit good starting characteristics at the time of resumption of operation.

To cope with such a case, preferably, the membrane-electrode assembly comprises an electrolyte membrane selectively allowing hydroxide ions to pass therethrough; an anode electrode layer formed on one surface of the electrolyte membrane, dissociating molecular hydrogen contained in externally introduced fuel gas into atomic hydrogen and electrons, and solid-phase-diffusing dissociated atomic hydrogen; and a cathode electrode layer formed on the opposite surface of the electrolyte membrane and forming hydroxide ions from molecular oxygen contained in externally introduced oxidizer gas and electrons formed through dissociation by the anode electrode layer. In this case, the anode electrode layer preferably contains, as a predominant component, for example, a hydrogen storage alloy which absorbs and releases atomic hydrogen.

Since the anode electrode layer may predominantly be formed of a specific functional material such as a hydrogen storage alloy, the anode electrode layer can dissociate externally supplied molecular hydrogen (more specifically, hydrogen gas) into atomic hydrogen (more specifically, hydrogen ions) and electrons. Additionally, the anode electrode layer can cause dissociated atomic hydrogen to move toward the electrolyte membrane through solid-phase diffusion. The cathode electrode layer can form hydroxide ions and can supply the hydroxide ions (i.e., anions) to the electrolyte membrane. Thus, as the fuel cell generates electricity, water can be formed in the anode electrode layer. By means of forming water in the anode-electrode-layer-side space whose volume is large, formed water can be drained efficiently.

The anode electrode layer which contains a hydrogen storage alloy as a predominant component can absorb (store) a portion of hydrogen ions and can release the absorbed (stored) hydrogen ions. Thus, for example, even in a state where the concentration of nitrogen gas in the anode-electrode-layer-side space increases, the anode electrode layer can release absorbed (stored) hydrogen ions immediately after start of operation of the fuel cell. That is, hydrogen ions required for reaction can be supplied, so that the fuel cell can exhibit good starting characteristics.

### BRIEF DESCRIPTION OF THE DRAWINGS

FIG. 1 is a sectional view schematically showing major portions of a single cell of a fuel cell according to an embodiment of the present invention;

FIG. 2 is a sectional view schematically showing a comparative structure of a single cell for explaining suppression of an increase in the concentration of nitrogen gas in an anode-electrode-layer-side space;

FIGS. 3A and 3B are views for explaining a change in partial pressure of nitrogen gas in the comparative structure of FIG. 2;

FIGS. 4A and 4B are views for explaining a change in partial pressure of nitrogen gas in the single-cell structure of FIG. 1;

FIG. 5 is a sectional view schematically showing major portions of a single cell of a fuel cell according to a first modified embodiment of the present invention; and

FIG. 6 is a sectional view schematically showing major portions of a single cell of a fuel cell according to a second modified embodiment of the present invention.

### BEST MODE FOR CARRYING OUT THE INVENTION

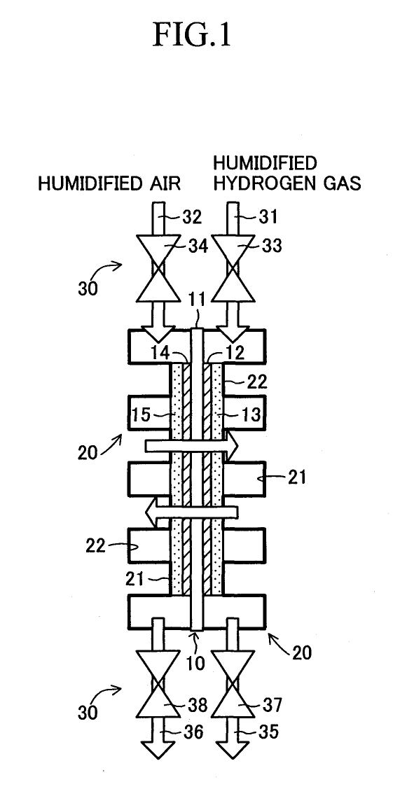

Embodiments of the present invention will next be described in detail with reference to the drawings. FIG. 1 schematically shows major portions of a single cell of a fuel cell (more specifically, a polymer electrolyte fuel cell) according to an embodiment of the present invention. A plurality of cells are stacked to form a fuel cell stack. The single cell includes an MEA 10. When fuel gas and oxidizer gas are supplied to the single cell from the exterior of the fuel cell stack, the single cell generates electricity by electrode reaction.

The MEA 10 includes an electrolyte membrane 11 which is formed of an ion exchange membrane. The electrolyte membrane 11 is formed of an ion exchange membrane (e.g., NAFION (registered trademark of a product of Du Pont)) which selectively allows cations (more specifically, hydrogen ions (H⁺)) to pass therethrough. A catalyst layer 12 and a gas diffusion layer 13 are formed on the electrolyte membrane 11 to which fuel gas (e.g., hydrogen gas) is introduced; i.e., layers 12 and 13 are provided on one surface of the membrane 11 that is close to an anode electrode layer. Also, a catalyst layer 14 and a gas diffusion layer 15 are formed on the electrolyte membrane 11 to which oxidizer gas (e.g., air) is introduced; i.e., layers 14 and 15 are provided on the opposite surface of the membrane 11 that is close to a cathode electrode layer.

The catalyst layer 12, which partially constitutes an anode electrode layer, and the catalyst layer 14, which partially constitutes a cathode electrode layer, contain, as a predominant component, carbon which carries noble-metal catalyst (e.g., platinum) thereon (hereinafter, the carbon is called carrier carbon). Specifically, carrier carbon is dispersed in water. The resultant dispersion liquid is mixed with a repellent, such as isopropyl alcohol or poly-tetra fluoro ethylene (PTFE), and a binder formed of a cation exchange resin (e.g., NAFION (registered trademark) solution). The resultant mixture is kneaded. The kneaded solid is applied onto the gas diffusion layers 13 and 15, thereby forming the catalyst layers 12 and 14.

The gas diffusion layer 13, which partially constitutes the anode electrode layer, and the gas diffusion layer 15, which partially constitutes the cathode electrode layer, are air-permeable and are adapted to supply hydrogen gas and air introduced through separators 20, which will be described later, to the catalyst layer 12 and the catalyst layer 14, respectively, in a uniformly diffused manner. Each of the gas diffusion layers 13 and 15 includes a repellent layer and a substrate. The repellent layer is formed by, for example, binding carbon particles with resin (e.g., PTFE). The substrate is formed of, for example, carbon fiber. With the catalyst layers 12 and 14 having been formed, through coating, on the respective repellent layers of the gas diffusion layers 13 and 15, the gas diffusion layers 13 and 15 are joined to the electrolyte membrane 11 by, for example, hot pressing.

The separators 20 are provided on the anode electrode layer and on the cathode electrode layer of the thus-configured MEA 10. The separators 20 have a function of supplying to the MEA 10 hydrogen gas and air introduced from the exterior of the fuel cell and a function of collecting electricity which is generated through reaction in the MEA 10. The separators 20 are formed of, for example, a stainless steel sheet. As shown in FIG. 1, a large number of streaky recess portions 21 and streaky projection portions 22 are formed on the stainless steel sheet and collectively serve as a gas passageway. As shown in FIG. 1, the separators 20 are provided in close contact with the electrolyte membrane 11 of the MEA 10. In place of the stainless steel sheet, for example, a steel sheet which has undergone anticorrosive treatment such as gold plating may be used to form the separators 20. In place of metal, for example, an electrically conductive nonmetal material such as carbon may also be used to form the separators 20.

A gas supply-discharge passageway 30 is attached to the fuel cell stack, in which a plurality of cells are stacked. Fuel gas and oxidizer gas (hereinafter, may be collectively called gas) are externally supplied to the fuel cell stack through the gas supply-discharge passageway 30. Also, unreacted gas is discharged to the exterior of the fuel cell stack through the gas supply-discharge passageway 30. As shown in FIG. 1, the gas supply-discharge passageway 30 includes a hydrogen gas supply pipe 31 for introducing hydrogen gas which is humidified by an unillustrated humidifier (hereinafter, hydrogen gas which is humidified is called humidified hydrogen gas) to the fuel cell stack (more specifically, to the anode electrode layer of each cell), and an air supply pipe 32 for introducing air which is humidified by an unillustrated humidifier (hereinafter, air which is humidified is called humidified air) to the fuel cell stack (more specifically, to the cathode electrode layer of each cell).

Valves 33 and 34 disposed on the gas supply line (hereinafter referred to as gas-supply-side valves 33 and 34) for allowing introduction of or shutting off humidified hydrogen gas and humidified air, respectively, are installed in the hydrogen gas supply pipe 31 and the air supply pipe 32, respectively. The gas-supply-side valves 33 and 34 are, for example, solenoid valves which have a plurality of port positions and in which a port position for allowing introduction of gas is changed over by electrical control to and from a port position for inhibiting introduction of gas. The gas-supply-side valves 33 and 34 are disposed in the vicinity of an unillustrated inlet for introducing gas into the fuel cell stack; in other words, in the vicinity of a position of connection between the fuel cell stack, and the hydrogen gas supply pipe 31 and the air supply pipe 32.

Also, the gas supply-discharge passageway 30 includes a hydrogen gas discharge pipe 35 for discharging, to the exterior of the fuel cell stack, unreacted, humidified hydrogen gas which has flown in the anode electrode layer of each cell, and an air discharge pipe 36 for discharging, to the exterior of the fuel cell stack, unreacted, humidified air which has flown in the cathode electrode layer of each cell. Valves 37 and 38 disposed on the gas discharge line (hereinafter referred to as gas-discharge-side valves 37 and 38) for allowing discharge of or shutting off unreacted, humidified hydrogen gas and unreacted, humidified air, respectively, are installed in the hydrogen gas discharge pipe 35 and the air discharge pipe 36, respectively. The gas-discharge-side valves 37 and 38 are also solenoid valves which are configured similarly to the gas-supply-side valves 33 and 34. The gas-discharge-side valves 37 and 38 are disposed in the vicinity of an unillustrated outlet for discharging gas from inside the fuel cell stack; in other words, in the vicinity of a position of connection between the fuel cell stack, and the hydrogen gas discharge pipe 35 and the air discharge pipe 36. Unreacted hydrogen gas flows through the hydrogen gas discharge pipe 35. Thus, in order to reuse unreacted hydrogen gas, for example, the hydrogen gas discharge pipe 35 is connected to the hydrogen gas supply pipe 31.

When hydrogen gas and air are externally supplied to the thus-configured fuel cell stack, a chemical reaction (hereinafter called an electrode reaction) occurs on the anode electrode layer and the cathode electrode layer of the MEA 10, whereby the fuel cell generates electricity and supplies generated electricity to the exterior thereof. The electrode reaction will next be described briefly. In a state where the fuel cell generates electricity (hereinafter called an active state), ports of the gas-supply-side valves 33 and 34 and ports of the gas-discharge-side valves 37 and 38 are changed over so as to allow introduction of gas.

First, in the anode electrode layer, hydrogen gas which is supplied from the exterior of the fuel cell through the hydrogen gas supply pipe 31 and the gas-supply-side valve 33 flows through the streaky recess portions 21 of the separator 20, whereby the hydrogen gas is supplied to the gas diffusion layer 13. The hydrogen gas supplied to the gas diffusion layer 13 diffuses uniformly and is supplied toward the catalyst layer 12. The catalyst layer 12 dissociates the supplied hydrogen gas into hydrogen ions and electrons. Dissociated hydrogen ions (i.e., cations) move through the electrolyte membrane 11 toward the cathode electrode layer. Dissociated electrons are supplied to the cathode electrode layer via an unillustrated external circuit. By means of electrons flowing through the external circuit, the fuel cell can supply electricity to the exterior thereof.

In the cathode electrode layer, air which is supplied from the exterior of the fuel cell through the air supply pipe 32 and the gas-supply-side valve 34 flows through the streaky projection portions 22 of the separator 20, whereby the air is supplied to the gas diffusion layer 15. The air supplied to the gas diffusion layer 15 diffuses uniformly and is supplied toward the catalyst layer 14. The catalyst layer 14 forms water from oxygen contained in the supplied air, hydrogen ions, and electrons. These electrode reactions can be expressed by the following Reaction Formulas 1 and 2.

Anode electrode layer: H₂→2H⁺+2e⁻ Reaction Formula 1

Cathode electrode layer: 2H⁺+2e⁺+(1/2)O₂→H₂O Reaction Formula 2

When supply of gas to the fuel cell in an active state is stopped, the electrode reactions of Reaction Formulas 1 and 2 stop, and the fuel cell is brought to a state where operation is suspended (hereinafter called an inactive state). In the fuel cell in an inactive state, ports of the gas-supply-side valves 33 and 34 and ports of the gas-discharge-side valves 37 and 38 are changed over to respective ports for inhibiting introduction of gas.

When the ports of the valves 33, 34, 37, and 38 are changed over as mentioned above, the interior of the fuel cell stack is brought to a closed state. Specifically, in each cell, a space defined by the electrolyte membrane 11 in the anode electrode layer of the MEA 10, the streaky recess portions 21 of the separator 20, the hydrogen gas supply pipe 31, and the hydrogen gas discharge pipe 37 (hereinafter called an anode-electrode-layer-side space) is closed by means of the gas-supply-side valve 33 and the gas-discharge-side valve 37. Also, a space defined by the electrolyte membrane 11 in the cathode electrode layer of the MEA 10, the streaky projection portions 22 of the separator 20, the air supply pipe 32, and the air discharge pipe 36 (hereinafter called a cathode-electrode-layer-side space) is closed by means of the gas-supply-side valve 34 and the gas-discharge-side valve 38.

By means of closing the anode-electrode-layer-side space and the cathode-electrode-layer-side space, even when the anode-electrode-layer-side space filled with hydrogen gas, and the cathode-electrode-layer-side space filled with nitrogen gas contained in air permit passage of these gases through the electrode membrane 11 in mutually opposite directions; i.e., even when cross-leak occurs, an increase in the concentration of nitrogen gas in the anode-electrode-layer-side space can be suppressed. This will be specifically described below.

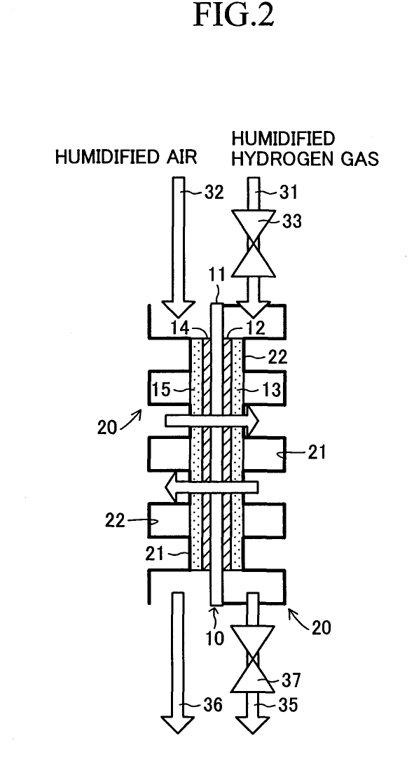

In order to facilitate understanding of suppression of an increase in the concentration of nitrogen gas in the anode-electrode-layer-side space, a single-cell structure of FIG. 2 in which the cathode-electrode-layer-side space is not closed is taken up as a comparative structure. In this comparative structure, the anode-electrode-layer-side space is closed by means of the gas-supply-side valve 33 and the gas-discharge-side valve 37, whereas the cathode-electrode-layer-side space communicates at all times with the exterior of the fuel cell stack via the air supply pipe 32 and the air discharge pipe 36. Accordingly, even in an inactive state of the fuel cell, air (humidified air) is introduced to the cathode electrode layer.

A fuel cell which employs the comparative structure will be studied for concentration change of nitrogen gas in the anode-electrode-layer-side space when the cell is in an inactive state. Immediately after the fuel cell is brought into an inactive state, the anode-electrode-layer-side space is filled with pure hydrogen gas. In other words, oxygen gas and nitrogen gas which constitute air present in the cathode electrode layer are absent in the anode-electrode-layer-side space. Thus, the anode-electrode-layer-side space and the cathode electrode layer differ in the concentration of oxygen gas and the concentration of nitrogen gas; i.e., in partial pressure of oxygen gas and partial pressure of nitrogen gas, while being separated by the electrolyte membrane 11 of the MEA 10.

In such a state where the anode-electrode-layer-side space and the cathode electrode layer differ in partial pressure of gas, oxygen gas and nitrogen gas pass through the electrolyte membrane 11 from the cathode electrode layer to the anode-electrode-layer-side space so that the anode-electrode-layer-side space and the cathode electrode layer show the same partial pressure of oxygen gas and the same partial pressure of nitrogen gas (i.e., so as to establish a state of equilibrium). Because of the presence of the catalyst layer 12, oxygen gas which has reached the anode-electrode-layer-side space reacts with hydrogen gas to form water, and is consumed. Accordingly, oxygen gas does not exist as impurities in the anode-electrode-layer-side space.

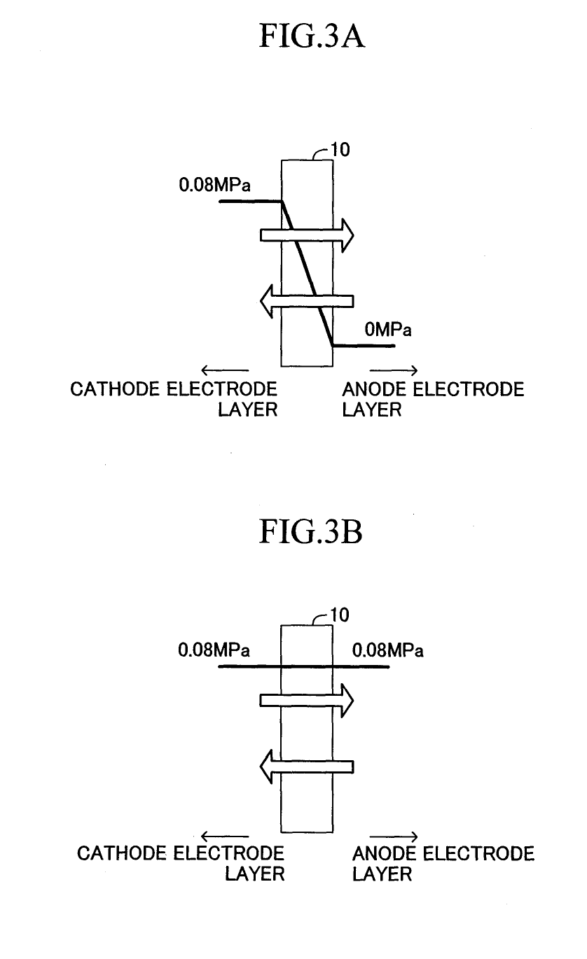

By contrast, since nitrogen gas is an inert gas, nitrogen gas exists stably in the anode-electrode-layer-side space. Accordingly, nitrogen gas exists as impurities in the anode-electrode-layer-side space. This passage of nitrogen gas will be described specifically with reference to FIG. 3. As mentioned above, immediately after the fuel cell which employs the comparative structure is brought to an inactive state, as shown in FIG. 3A, the cathode electrode layer shows a partial pressure of nitrogen gas of 0.08 MPa, which is equal to the partial pressure of nitrogen gas in air, since the cathode electrode layer communicates with the exterior of the fuel cell stack. Meanwhile, the anode-electrode-layer-side space is filled with pure hydrogen gas and thus shows a partial pressure of nitrogen gas of 0 MPa.

As time elapses from this state, differential partial pressure causes nitrogen gas to pass through the electrolyte membrane 11 from the cathode electrode layer to the anode-electrode-layer-side space. Since nitrogen gas can be externally supplied freely at all times, as shown in FIG. 3B, partial pressure of nitrogen gas in the anode-electrode-layer-side space increases up to 0.08 MPa. In other words, the concentration of nitrogen gas in the anode-electrode-layer-side space increases so that partial pressure of nitrogen gas reaches 0.08 MPa. Thus, when the fuel cell is again brought to an active state, nitrogen gas which is present in the anode-electrode-layer-side space and serves as impurities hinders progress of the reaction of Reaction Formula 1, resulting in a drop in electricity-generating efficiency of the fuel cell.

The anode electrode layer and the cathode electrode layer differ in partial pressure of hydrogen gas. Thus, hydrogen gas passes through the electrolyte membrane 11 of the MEA 10 from the anode electrode layer to the cathode electrode layer. However, since the cathode electrode layer is open, hydrogen gas which has reached the cathode electrode layer is discharged, together with air, to the exterior of the fuel cell stack. Therefore, passage of hydrogen gas occurring during an inactive state of the device does not adversely affect the electricity-generating efficiency of the fuel cell.

Meanwhile, in the structure of the present embodiment in which the anode-electrode-layer-side space and the cathode-electrode-layer-side space are closed, like the case of the above-described comparative structure, the anode-electrode-layer-side space and the cathode-electrode-layer-side space differ in partial pressure of nitrogen gas. When the fuel cell is brought to an inactive state, the anode-electrode-layer-side space and the cathode-electrode-layer-side space are closed by means of the gas-supply-side valves 33 and 34, respectively, and by means of the gas-discharge-side valves 37 and 38, respectively. Accordingly, the anode-electrode-layer-side space is filled with hydrogen gas, and the cathode-electrode-layer-side space is filled with air.

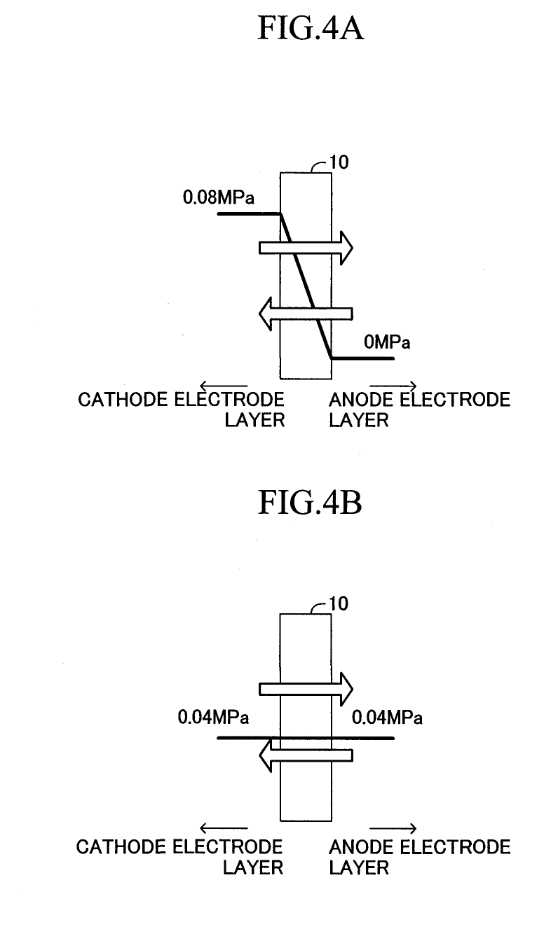

Accordingly, the anode-electrode-layer-side space and the cathode-electrode-layer-side space differ in partial pressure of nitrogen gas. Specifically, immediately after the fuel cell is brought to an inactive state, as shown in FIG. 4A, the cathode-electrode-layer-side space shows a partial pressure of nitrogen gas of 0.08 MPa, which is equal to the partial pressure of nitrogen gas in air, whereas the anode-electrode-layer-side space shows a partial pressure of nitrogen gas of 0 MPa. Thus, as in the case of the above-described comparative structure, in order to establish a state of equilibrium in terms of partial pressure of nitrogen gas, nitrogen gas passes through the electrolyte membrane 11 of the MEA 10 from the cathode-electrode-layer-side space to the anode-electrode-layer-side space.

The anode-electrode-layer-side space and the cathode-electrode-layer-side space are closed by means of the gas-supply-side valves 33 and 34, respectively, which are disposed in the vicinity of an inlet for introducing gas into the fuel cell stack, and by means of the gas-discharge-side valves 37 and 38, respectively, which are disposed in the vicinity of an outlet for discharging unreacted gas from the fuel cell stack. Therefore, the anode-electrode-layer-side space and the cathode-electrode-layer-side space each assume a minimum volume equal to that when the fuel cell stack is formed. In particular, by means of minimizing the volume of the cathode-electrode-layer-side space, the quantity of confined air is minimized.

Accordingly, the quantity of nitrogen gas that can permeate to the anode-electrode-layer-side space is limited. Thus, as time elapses after the fuel cell is brought to an inactive state, as shown in FIG. 4B, the anode-electrode-layer-side space and the cathode-electrode-layer-side space both assume a partial pressure of nitrogen gas of 0.04 MPa. In other words, the concentration of nitrogen gas in the anode-electrode-layer-side space increases so that partial pressure of nitrogen gas becomes 0.04 MPa.

As described above, by means of closing the cathode-electrode-layer-side space; more specifically, by means of shutting off supply of nitrogen gas, an increase in the concentration of nitrogen gas in the anode-electrode-layer-side space can be effectively suppressed. In the comparative structure, when the fuel cell is in an inactive state, partial pressure of nitrogen gas (in other words, concentration of nitrogen gas) in the anode-electrode-layer-side space increases until the partial pressure becomes that in air. By contrast, in the structure of the present embodiment, an increase in partial pressure of nitrogen gas (in other words, concentration of nitrogen gas) in the anode-electrode-layer-side space is suppressed to a low level. Because of a low concentration of nitrogen gas which is present as impurities in the anode-electrode-layer-side space, when the fuel cell is again brought to an active state, the reaction of Reaction Formula 1 progresses in a favorable manner, thereby suppressing a drop in electricity-generating efficiency of the fuel cell.

As is understood from the above description, according to the fuel cell of the present invention, particularly by closing the cathode-electrode-layer-side space, introduction of new air and discharge of air are prevented, thereby reliably reducing an increase in the concentration of nitrogen gas in the anode-electrode-layer-side space. This greatly reduces impurities present in the anode-electrode-layer-side space of the fuel cell in an inactive state, so that, when the fuel cell is again brought to an active state, electrode reactions in the MEA 10 can progress promptly and smoothly. Thus, the fuel cell can exhibit good starting characteristics and can provide improved convenience.

In the present embodiment, the gas-supply-side valves 33 and 34 and the gas-discharge-side valves 37 and 38 close the anode-electrode-layer-side space and the cathode-electrode-layer-side space of the fuel cell stack such that the spaces have the same volume; more specifically, the spaces are minimized in volume. Particularly, by means of minimizing the volume of the cathode-electrode-layer-side space, the quantity of nitrogen gas contained in air confined in the anode-electrode-layer-side space can be minimized; as a result, an increase in the concentration of nitrogen gas in the anode-electrode-layer-side space can be suppressed. Accordingly, when the fuel cell is again brought to an active state, the reaction of Reaction Formula 1 progresses promptly, whereby electricity-generating efficiency in the fuel cell can be improved.

In addition to the above, by means of reducing the relative concentration of nitrogen gas with respect to the concentration of hydrogen gas in the anode-electrode-layer-side space, the reaction of Reaction Formula 1 can be started more promptly and smoothly. A first modified embodiment of the present invention for implementing this will next be described. In the description of the first modified embodiment, like parts of the above-described embodiment and the first modified embodiment are denoted by like reference numerals, and repeated description thereof is omitted.

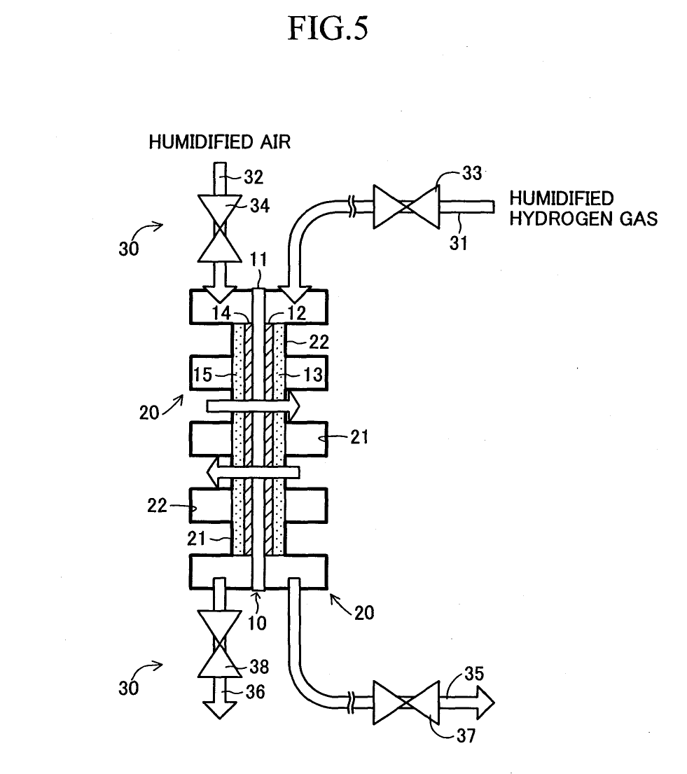

As shown in FIG. 5, in the first modified embodiment, the gas-supply-side valve 33 and the gas-discharge-side valve 37 for closing the anode-electrode-layer-side space are installed in the hydrogen gas supply pipe 31 and the hydrogen gas discharge pipe 35, respectively, while being located away from the inlet and the outlet, respectively, of the fuel cell stack. By means of disposing the gas-supply-side valve 33 and the gas-discharge-side valve 37 in this manner, the volume of the anode-electrode-layer-side space can be made large as compared with the volume of the cathode-electrode-layer-side space.

Also, in the first modified embodiment, when the fuel cell is brought to an inactive state, ports of the gas-supply-side valves 33 and 34 and ports of the gas-discharge-side valves 37 and 38 are changed over to a port mode that inhibits introduction of gas as in the case of the above-described embodiment. Since this procedure causes the anode-electrode-layer-side space and the cathode-electrode-layer-side space to be closed, as in the case of the above-described embodiment, even when nitrogen gas passes through the electrolyte membrane 11 of the MEA 10 from the cathode-electrode-layer-side space to the anode-electrode-layer-side space, an increase in the concentration of nitrogen gas in the anode-electrode-layer-side space can be suppressed.

According to the first modified embodiment, the volume of the anode-electrode-layer-side space is greater than the volume of the cathode-electrode-layer-side space. Thus, even when nitrogen gas passes through the electrolyte membrane 11 from the cathode-electrode-layer-side space to the anode-electrode-layer-side space, an increase in the relative concentration of nitrogen gas with respect to the concentration of hydrogen gas in the anode-electrode-layer-side space can be suppressed to a low level. This results in an increase in the relative concentration of hydrogen gas present around the catalyst layer 12 of the anode electrode layer, so that, when the fuel cell is again brought to an active state, the reaction of Reaction Formula 1 can be started promptly. Thus, the fuel cell can start to generate electricity promptly and smoothly and can exhibit improved electricity-generating efficiency.

In the above-described first modified embodiment, the gas-supply-side valve 33 and the gas-discharge-side valve 37 for closing the anode-electrode-layer-side space are changed in position of installment so as to increase the volume of the anode-electrode-layer-side space. In other words, by increasing the volume of the hydrogen gas supply pipe 31 and the hydrogen gas discharge pipe 35, which partially constitute the anode-electrode-layer-side space, the volume of the anode-electrode-layer-side space is increased.

In place of the above, the separator 20 used to form the anode-electrode-layer-side space and the separator 20 used to form the cathode-electrode-layer-side space can have different shapes. A second modified embodiment of the present invention for implementing this will next be described. Like parts of the above-described embodiment and the second modified embodiment are denoted by like reference numerals, and repeated description thereof is omitted.

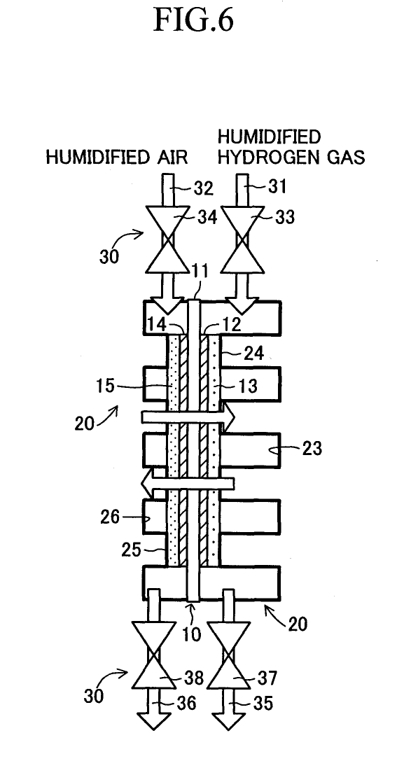

As shown in FIG. 6, in the second modified embodiment, streaky recess portions 23 and streaky projection portions 24 of the separator 20 used to form the anode-electrode-layer-side space are greater in depth/height than the streaky recess portions 21 and the streaky projection portions 22 of the separator 20 employed in the above-described embodiment. As for the separator 20 used to form the cathode-electrode-layer-side space in the second modified embodiment, streaky recess portions 25 and streaky projection portions 26 are smaller in depth/height than the streaky recess portions 21 and the streaky projection portions 22.

As described above, the separator 20 on which the streaky recess portions 23 and the streaky projection portions 24 are formed is used to form the anode-electrode-layer-side space, and the separator 20 on which the streaky recess portions 25 and the streaky projection portions 26 are formed is used to form the cathode-electrode-layer-side space, whereby the spaces can differ in volume from each other. More specifically, the volume of the anode-electrode-layer-side space can be made greater than the volume of the cathode-electrode-layer-side space. Accordingly, the second modified embodiment can also be expected to yield an effect similar to that of the above-described embodiment and the above-described first modified embodiment.

In the case where the volume of the cathode-electrode-layer-side space is made small as in the case of the second modified embodiment, drainage of water formed by the reaction of Reaction Formula 2 may be impaired. By contrast, the volume of the anode-electrode-layer-side space is increased. Thus, if formation of water by an electrode reaction is performed in the anode electrode layer, formed water can be efficiently drained. In this case, the electrolyte membrane 11 of the MEA 10 may be formed of an ion exchange membrane (e.g., NEOCEPTOR (registered trademark of a product of Tokuyama)) which selectively allows anions (more specifically, hydroxide ions (OH⁺)) to pass therethrough. By use of such an ion exchange membrane, electrode reactions by the MEA 10 are expressed by the following Reaction Formulas 3 and 4. Water is formed in the anode electrode layer.

Anode electrode layer: H₂+2OH⁻→2H₂O+2e⁻ Reaction Formula 3

Cathode electrode layer: (1/2)O₂+H₂O+2e⁻→2OH⁻ Reaction Formula 4

In the case where water is formed in the anode electrode layer as described above, formed water may hinder supply of hydrogen gas; i.e., a flooding state may arise. This potentially causes a drop in electricity-generating efficiency of the fuel cell. In this case, in place of forming the anode electrode layer from the catalyst layer 12 and the gas diffusion layer 13 as in the case of the above-described embodiment, only a catalyst layer is formed in the anode electrode layer by use of a hydrogen storage alloy, thereby suppressing a drop in electricity-generating efficiency of the fuel cell which could otherwise result from occurrence of a flooding state.

A hydrogen storage alloy can dissociate molecular hydrogen; i.e., hydrogen gas, into atomic hydrogen (hydrogen ions (H⁺)) and electrons, and can absorb and release dissociated atomic hydrogen. A hydrogen storage alloy may be selected as appropriate from among, for example, AB₅-type hydrogen storage alloys, typified by LaNi₅; AB₂-type (Laves-phase-type) hydrogen storage alloys, typified by ZnMn₂ or substitution products thereof; A₂B-type hydrogen storage alloys, typified by Mg₂Ni or substitution products thereof; and solid-solution-type V-based hydrogen storage alloys. By forming a catalyst layer in the anode electrode layer by use of such a hydrogen storage alloy, hydrogen ions dissociated from supplied hydrogen gas can move to the electrolyte membrane 11 through solid-phase diffusion through the catalyst layer. In other words, when a catalyst layer is formed of a hydrogen storage alloy, supplied hydrogen gas does not need to undergo gaseous-phase diffusion to pass through grain boundaries of the catalyst layer in the anode electrode layer. Accordingly, even when a flooding state arises in the anode electrode layer, hydrogen ions required for an electrode reaction can be reliably moved toward the electrolyte membrane 11. Thus, a drop in electricity-generating efficiency of the fuel cell can be suppressed.

Also, hydrogen ions can be absorbed (stored) in the catalyst layer. Thus, for example, when the fuel cell in an inactive state is brought to an active state, absorbed (stored) hydrogen ions are released, whereby an electrode reaction can progress. Therefore, even in a state where the concentration of nitrogen gas in the anode-electrode-layer-side space increases, hydrogen ions required for an electrode reaction can be supplied in a favorable manner, so that electricity can be generated promptly and smoothly.

The present invention is not limited to the above embodiment and modified embodiments, but may be embodied in various other forms without departing from the spirit and purport of the invention.

For example, according to the above second modified embodiment, by means of changing the depth/height of the streaky recess portions and streaky projection portions of the separators 20, the volume of the anode-electrode-layer-side space is made greater than the volume of the cathode-electrode-layer-side space. However, by means of changing the width of the streaky recess portions and streaky projection portions of the separators 20, the volume of the anode-electrode-layer-side space can also be made greater than the volume of the cathode-electrode-layer-side space. Specifically, the width of the streaky recess portions of the fuel-side separator used to form the anode-electrode-layer-side space is made greater than the width of the streaky projection portions of the oxidizer-side separator used to form the cathode-electrode-layer-side space.

According to the above embodiment and modified embodiments, the streaky recess portions 21, 23, and 25 or the streaky projection portions 22, 24, and 26, which serve as gas passageways of the separators 20, assume a rectangular, cross-sectional shape. However, the gas passageways may assume other cross-sectional shapes. Even when other cross-sectional shapes are employed, an effect similar to that of the above embodiment and modified embodiments can be expected.

According to the above embodiment and modified embodiments, the gas-supply-side valve 34 and the gas-discharge-side valve 38 which are electrically controllable are employed as closing means to be installed in the air supply pipe 32 and the air discharge pipe 36, respectively. However, for example, in the case where the fuel cell stack directly introduces air thereinto; i.e., in the case where the air supply pipe 32 and the air discharge pipe 36 are not provided, cover members capable of closing an inlet and an outlet formed in the fuel cell stack may be employed as the closing means. In this case, the degree of sealing the cathode-electrode-layer-side space is slightly inferior to the embodiment and modified embodiments. However, since introduction of new air to and discharge of air from the cathode-electrode-layer-side space can be suppressed, an effect similar to that of the above embodiment and modified embodiments can be expected.

According to the above embodiment and modified embodiments, the separators 20 are formed from a stainless steel sheet. Alternatively, in order to more efficiently supply fuel gas and oxidizer gas, the separators may be composed of a flat-plate-like separator body and a gas passageway formation member, wherein the separator body functions to prevent mixed flow of gases, and the gas passageway formation member is configured such that a large number of streaky recess portions and streaky projection portions are formed on a material in which a large number of through holes are formed (e.g., an expanded metal in which a large number of meshy through holes are formed, or a punched metal in which a large number of through holes are formed).

### INDUSTRIAL APPLICABILITY

The present invention can be applied to a polymer electrolyte fuel cell whose electrode structure includes a solid polymer membrane.

1. A fuel cell comprising:
a membrane-electrode assembly comprising an electrolyte membrane selectively allowing hydroxide ions to pass therethrough; an anode electrode layer formed on one surface of the electrolyte membrane, dissociating molecular hydrogen contained in externally introduced fuel gas into atomic hydrogen and electrons, and solid-phase-diffusing dissociated atomic hydrogen; and a cathode electrode layer formed on the opposite surface of the electrolyte membrane and forming hydroxide ions from molecular oxygen contained in externally introduced oxidizer gas and electrons formed through dissociation by the anode electrode layer.
fuel-side and oxidizer-side separators providing gas passageways for introducing fuel gas and oxidizer gas into the membrane-electrode assembly, wherein the gas passageways formed by plurality of streaky recess portions and streaky projection portions;
a gas supply-discharge member for externally supplying the fuel gas and the oxidizer gas to and discharging unreacted fuel gas and unreacted oxidizer gas from a fuel cell stack comprising a plurality of cells each including at least the membrane-electrode assembly and the separators; and
a closing member for closing an anode-electrode-layer-side space and a cathode-electrode-layer-side space, the anode-electrode-layer-side space being defined by the membrane-electrode assembly, the gas passageway of the fuel-side separator, and the gas supply-discharge member and including the anode electrode layer, and the cathode-electrode-layer-side space being defined by the membrane-electrode assembly, the gas passageway of the oxidizer-side separator, and the gas supply-discharge member and including the cathode electrode layer,
wherein the streaky recess portions or the streaky projection portions of the fuel-side separator used to form the anode-electrode-layer-side space are greater in size than the streaky recess portions or the streaky projection portions of the oxidizer-side separator used to form the cathode-electrode-layer-side space.

2. A fuel cell comprising:
a membrane-electrode assembly comprising an electrolyte membrane formed of an ion exchange membrane, an anode electrode layer formed on one surface of the electrolyte membrane, and a cathode electrode layer formed on the opposite surface of the electrolyte membrane;
fuel-side and oxidizer-side separators providing gas passageways for introducing fuel gas and oxidizer gas into the membrane-electrode assembly;
a gas supply-discharge member for externally supplying the fuel gas and the oxidizer gas to and discharging unreacted fuel gas and unreacted oxidizer gas from a fuel cell stack comprising a plurality of cells each including at least the membrane-electrode assembly and the separators; and
a closing member for closing an anode-electrode-layer-side space and a cathode-electrode-layer-side space, the anode-electrode-layer-side space being defined by the membrane-electrode assembly, the gas passageway of the fuel-side separator, and the gas supply-discharge member and including the anode electrode layer, and the cathode-electrode-layer-side space being defined by the membrane-electrode assembly, the gas passageway of the oxidizer-side separator, and the gas supply-discharge member and including the cathode electrode layer,
wherein the closing member for closing the cathode-electrode-layer-side space is disposed in the vicinity of a position of connection between the fuel cell stack and the gas supply-discharge member; and
wherein the closing member for closing the anode-electrode-layer-side space is disposed in away from the position of connection between the fuel cell stack and the gas supply-discharge member

3. (canceled)

4. (canceled)

5. (canceled)

6. A fuel cell according to claim 1, wherein the anode electrode layer contains, as a predominant component, a hydrogen storage alloy which absorbs and releases atomic hydrogen.
